(19) United States
(12) Patent Application Publication
(10) Pub. No.: US 2026/0111228 A1
(43) Pub. Date: Apr. 23, 2026

(54) SYSTEM FOR TRAINING A NEURAL NETWORK USING GENERALIZED POLYDOT CODING

(71) Applicants: CARNEGIE MELLON UNIVERSITY, Pittsburgh, PA (US); THE PENN STATE RESEARCH FOUNDATION, University Park, PA (US)

(72) Inventors: Pulkit Grover, Pittsburgh, PA (US); Haewon Jeong, Pittsburgh, PA (US); Yaoqing Yang, Pittsburgh, PA (US); Sanghamitra Dutta, Pittsburgh, PA (US); Ziqian Bai, Pittsburgh, PA (US); Tze Meng Low, Pittsburgh, PA (US); Mohammad Fahim, University Park, PA (US); Farzin Haddadpour, University Park, PA (US); Viveck Cadambe, University Park, PA (US)

(73) Assignees: CARNEGIE MELLON UNIVERSITY, Pittsburgh, PA (US); THE PENN STATE RESEARCH FOUNDATION, University Park, PA (US)

(21) Appl. No.: 19/419,508

(22) Filed: Dec. 15, 2025

Related U.S. Application Data
(63) Continuation of application No. 16/588,990, filed on Sep. 30, 2019, now abandoned.
(60) Provisional application No. 62/766,079, filed on Sep. 28, 2018.

(51) Int. Cl. G06F 9/30; G06N 3/04; G06N 3/084

(52) U.S. Cl. CPC G06F 9/3001; G06F 9/30036; G06N 3/04; G06N 3/084

(57) ABSTRACT

Disclosed herein is a system for more efficient training of a neural network that uses a novel coding technique, referred to herein as Generalized PolyDot Coding, for calculating matrix-vector products. The Generalized PolyDot Coding advances on existing techniques for coded matrix operations under storage and communication constraints. The system is resistant to soft errors and provides a trade-off between error resistance and communication cost.

### RELATED APPLICATIONS

This application is a continuation of U.S. patent application Ser. No. 16/588,900, filed Sep. 30, 2019, which claims the benefit of U.S. Provisional Patent Application Ser. No. 62/766,079, filed Sep. 28, 2018, the entire contents of which are incorporated herein by reference in their entirety.

### GOVERNMENT INTEREST

This invention was made with government support under contracts CNS-1702694, CNS-1553248, CNS-1464336 and CNS-1350314, awarded by the National Science Foundation (NSF). The government has certain rights in the invention.

### BACKGROUND OF THE INVENTION

As the era of big data advances, massive parallelization has emerged as a natural approach to overcome limitations imposed by saturation of Moore's Law (and thereby of single processor compute speeds). However, massive parallelization leads to computational bottlenecks due to faulty nodes and stragglers. Stragglers refer to a few slow or delay-prone processors that can bottleneck the entire computation because one has to wait for all the parallel nodes to finish. The issue of straggling and faulty nodes has been a topic of active interest in the emerging area of “coded computation”. Coded computation not only advances on coding approaches in classical works in Algorithm-Based Fault Tolerance (ABFT), but also provides novel analyses of required computation time (e.g., expected time and deadline exponents). Perhaps most importantly, it brings an information-theoretic lens to the problem by examining fundamental limits and comparing them with existing strategies.

Matrix multiplication is central to many modern computing applications, including machine learning and scientific computing. There is a lot of interest in classical ABFT literature and more recently in coded computation literature to make matrix multiplications resilient to faults and delays. In particular, coded matrix-multiplication constructions called Polynomial Codes outperform prior art methods in terms of the recovery threshold and the minimum number of successful (non-delayed, non-faulty) processing nodes required for completing the computation.

Deep neural networks (DNNs) are becoming increasingly important in many technology areas, with applications such as image processing in safety and time critical computations (e.g. automated cars) and healthcare. Thus, reliable training of DNNs is becoming increasingly important.

Soft-errors refer to undetected errors, e.g. bit-flips or gate errors in computation, caused by several factors, e.g., exposure of chips to cosmic rays from outer space, manufacturing defects, and storage faults. Ignoring “soft-errors” entirely during the training of DNNs can severely degrade the accuracy of training.

Coded computing is a promising solution to the various problems arising from unreliability of processing nodes in parallel and distributed computing, such as straggling. Coded computing is a significant step in a long line of work on noisy computing that has led to Algorithm-Based Fault-Tolerance (ABFT), the predecessor of coded computing.

### SUMMARY OF THE INVENTION

The invention is directed to a setup having P worker nodes that perform the computation in a distributed manner and a master node that coordinates the computation The master node, for example, may perform low-complexity pre-processing on the inputs, distribute the inputs to the workers and aggregate the results of the workers possibly by performing some low complexity post-processing.

The use of MatDot codes as disclosed herein provide an advance on existing constructions in scaling. When the m^{th} fraction of each matrix can be stored in each worker node, Polynomial codes have the recovery threshold of m², while the recovery threshold of MatDot is only 2m−1. However, as discussed below, this comes at an increased per-worker communication cost. Also disclosed is the use of PolyDot codes that interpolate between MatDot and Polynomial code constructions in terms of recovery thresholds and communication costs.

While Polynomial codes have a recovery threshold of Θ(m²), MatDot codes have a recovery threshold of Θ(m) when each node stores only the m^{th} fraction of each matrix multiplicand. In the disclosed method, a systematic version of MatDot codes is used, where the operations of the first m worker nodes may be viewed as multiplication in uncoded form.

Also disclosed herein is the use of “PolyDot codes”, a unified view of MatDot and Polynomial codes that leads to a trade-off between recovery threshold and communication costs for the problem of multiplying square matrices. The recovery threshold of Polynomial codes can be reduced further using MatDot. Conceptually, PolyDot codes are a coded matrix multiplication approach that interpolates between the seminal polynomial codes for low communication costs) and MatDot codes (for highest error tolerance). The PolyDot method may be extended to multiplications involving more than two matrices.

Also disclosed herein is a novel unified coded computing technique that generalizes PolyDot codes for error-resilient matrix-vector multiplication, referred to herein as Generalized PolyDot.

Generalized PolyDot achieves the same erasure recovery threshold (and hence error tolerance) for matrix-vector products as that obtained with entangled polynomial codes proposed in literature for matrix-matrix products.

Generalized PolyDot is useful for error-resilient training of model parallel DNNs, and a technique for training a DNN using Generalized PolyDot is shown herein. However, the problem of DNN training imposes several additional difficulties that are also addressed herein:

Encoding overhead: Existing works on coded matrix-vector products require encoding of the matrix W, which is as computationally expensive as the matrix-vector product itself. Thus, these techniques are most useful if W is known in advance and is fixed over a large number of computations so that the encoding cost is amortized. However, when training DNNs, because the parameters update at every iteration, a naïve extension of existing techniques would require encoding or weight matrices at every iteration and thus introduce an undesirable additional overhead of Ω(N²) at every iteration. To address this, coding is weaved into operations of DNN training so that an initial encoding of the weight matrices is maintained across the updates. Further, to maintain the coded structure, only the vectors need to be encoded at every iteration, instead of matrices, thus adding negligible overhead.

Master node acting as a single point of failure: Because of the focus on soft-errors herein, unlike many other coded computing works, a completely decentralized setting, with no master node must be considered. This is because a master node can often become a single point of failure, an important concept in parallel computing.

Nonlinear activation between layers: The linear operations (matrix-vector products) at each layer are coded separately as they are the most critical and complexity-intensive steps in the training of DNNs as compared to other operations such as nonlinear activation or diagonal matrix post-multiplication, which are linear in vector length.

### BRIEF DESCRIPTION OF THE DRAWINGS

FIG. 1 is a block diagram of a computational system used to implement the present invention.

FIG. 2 graphically shows the computations made by each worker node in the multiplication of two matrices using a MatDot construction.

FIG. 3 is a graph showing the trade-off between communication cost and recovery threshold for m=36.

FIGS. 4A-4D graphically show the process of used Generalized PolyDot to train a DNN. FIG. 4A shows the operations performed in each layer during the feedforward stage; FIG. 4B shows the generation of the backpropagated error vector; FIG. 4C shows the backpropagation of the error from layer L to layer 1; and FIG. 4D shows the updating of the weight matrices at each layer.

### GLOSSARY

A computational system is defined as a distributed system comprising a master node, a plurality of worker nodes and a fusion node.

A master node is defined as a node in the computational system that receives computational inputs, pre-processes (e.g., encoding) the computational inputs, and distributes the inputs to the plurality of worker nodes.

A worker node is defined as a memory-constrained node that performs pre-determined computations on its respective input in parallel with other worker nodes.

A fusion node is defined as a node that receives outputs from successful worker nodes and performs post-processing (e.g., decoding) to recover a final computation output.

A successful worker is defined as a worker node that finishes its computation task successfully and sends its output to the fusion node.

A successful computation is defined as a computation wherein the computational system, wherein on receiving the inputs, produces the correct computational output.

A recovery threshold is defined as the worst-case minimum number of successful workers required by the fusion node to complete the computation successfully.

A row-block is defined as the submatrices formed when a matrix is split horizontally.

A column-block is defined as the submatrices formed a matrix is split vertically.

### DETAILED DESCRIPTION

For practical utility, it is important that the amount of processing that the worker nodes perform be much smaller than the processing at the master and fusion nodes. It is assumed that any worker node can fail to complete its computation because of faults or delays.

The total number of worker nodes is denoted as P, and the recovery threshold is denoted by k.

To form a row-block, matrix A is split horizontally as:

$$A = [ \begin{matrix}{A}_{0} \\ {A}_{1}\end{matrix} ] .$$

Similarly, to form a column-block matrix A is split vertically as: A=[A₀ A₁].

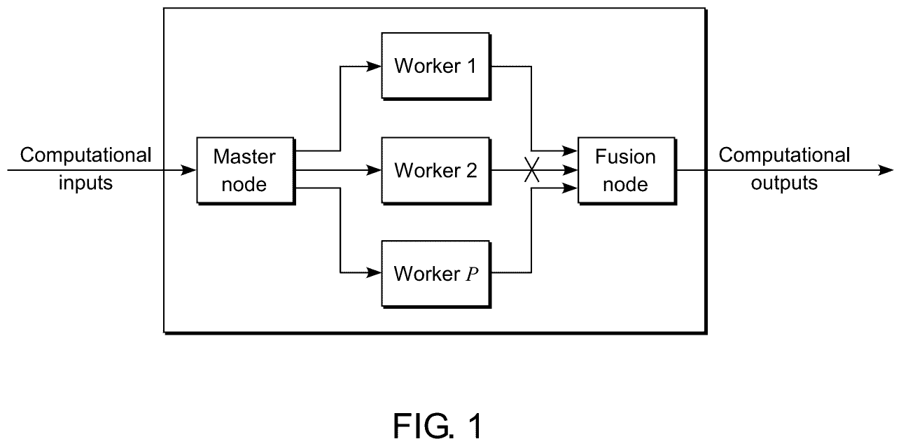

The invention will be described in terms of a problem of multiplying two square matrices A, B are in [symbol] (| [symbol] |<P), i.e., AB using the computational system shown in block diagram form in FIG. 1 and having the components defined above. Both the matrices are of dimension N×N, and each worker node can receive at most 2 N²/m symbols from the master node, where each symbol is an element of [symbol] . For simplicity, assume that m divides N and a worker node receives N²/m symbols from A and B each.

The computational complexities of the master and fusion nodes, in terms of the matrix parameter N, is required to be negligible in a scaling sense than the computational complexity at any worker node. The goal is to perform the matrix-matrix multiplication utilizing faulty or delay-prone worker nodes with minimum recovery threshold.

### MatDot Codes

The distributed matrix-matrix product strategy using MatDot codes will now be described. As a prelude to proceeding further into the detailed construction and analyses of MatDot codes, an example of the MatDot technique is provided where m=2 and k=3.

MatDot codes compute AB using P nodes such that each node uses N²/2 linear combinations of the entries of A and B and wherein the overall computation is tolerant to p−3 stragglers (i.e., 3 nodes suffice to recover AB). The proposed MatDot codes use the following strategy: Matrix A is split vertically and B is split horizontally as follows:

$$A = [ {A}_{0} {A}_{1} ] , B = [ \begin{matrix}{B}_{0} \\ {B}_{1}\end{matrix} ] \qquad ( 1 )$$

where A₀, A₁ are submatrices (or column-blocks) of A of dimension N×N/2 and B₀, B₁ are submatrices (or row-blocks) of B of dimension N/2×N.

Let p_{A}(x)=A₀+A₁x and p_{B}(x)=B₀x+B₁. Let x₁, x₂ . . . xₚ be distinct real numbers. The master node sends p_{A}(xᵣ) and p_{B}(xᵣ) to the r-th worker node where the r-th worker node performs the multiplication p_{A}(xᵣ)p_{B}(xᵣ) and sends the output to the fusion node.

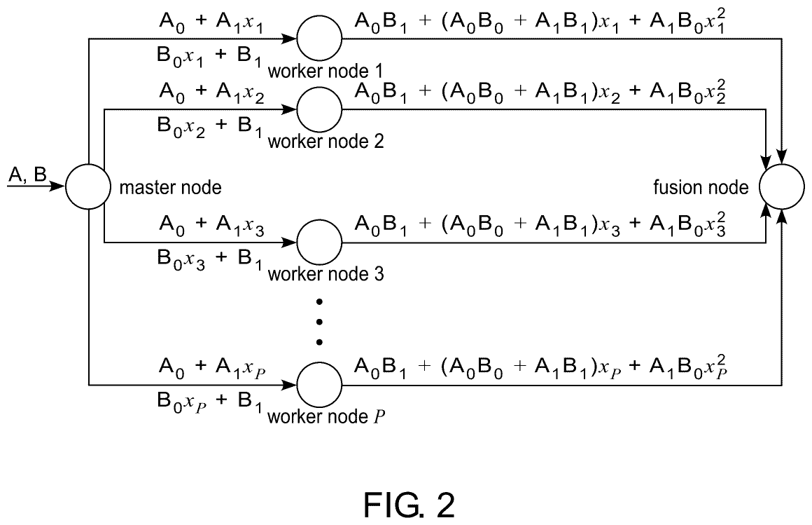

The exact computations at each worker node are depicted in FIG. 2. It can be observed that the fusion node can obtain the product AB using the output of any three successful workers as follows: Let the worker nodes 1, 2 and 3 he the first three successful worker nodes, then the fusion node obtains the following three matrices:

$${p}_{A} ( {x}_{1} ) {p}_{B} ( {x}_{1} ) = {A}_{0} {B}_{1} + ( {A}_{0} {B}_{0} + {A}_{1} {B}_{1} ) {x}_{1} + {A}_{1} {B}_{0} {x}_{1}^{2}$$

$${p}_{A} ( {x}_{2} ) {p}_{B} ( {x}_{2} ) = {A}_{0} {B}_{1} + ( {A}_{0} {B}_{0} + {A}_{1} {B}_{1} ) {x}_{2} + {A}_{1} {B}_{0} {x}_{2}^{2}$$

$${p}_{A} ( {x}_{3} ) {p}_{B} ( {x}_{3} ) = {A}_{0} {B}_{1} + ( {A}_{0} {B}_{0} + {A}_{1} {B}_{1} ) {x}_{3} + {A}_{1} {B}_{0} {x}_{3}^{2}$$

Because these three matrices can be seen as three evaluations of the matrix polynomial p_{A}(x)p_{B}(x) of degree 2 at three distinct evaluation points (x₁, x₂, x₃), the fusion node can obtain the coefficients of x in p_{A}(x)p_{B}(x) using polynomial interpolation. This includes the coefficient of x, which is A₀B₀+A₁B₁=AB. Therefore, the fusion node can recover the matrix product AB.

In this example, it can be seen that for m=2, the recovery threshold of MatDot codes is k=3, which is lower than Polynomial codes as well as ABTF matrix multiplication. It can be proven that, for any integer m, the recovery threshold of MatDot codes is k=2m−1.

### Construction of MatDot Codes

Matrix A is split vertically into m equal column-blocks of N²/m symbols each and matrix B is split horizontally into m equal row-blocks of N²/m symbols each) as follows:

$$A = [ {A}_{0} {A}_{1} ⋯ {A}_{m - 1} ] , B = [ \begin{matrix}{B}_{0} \\ {B}_{1} \\ ⋮ \\ {B}_{m - 1}\end{matrix} ] \qquad ( 2 )$$

where, for i=∈{0, . . . , m−1}, and Aᵢ, Bᵢ are N×N/m and N/m×N dimensional submatrices, respectively.

Master node (encoding): Let x₁, x₂ . . . xₚ be distinct elements in [symbol] . Let

$${p}_{A} ( x ) = {Σ}_{i = 0}^{m - 1} {A}_{i} {x}^{i} and$$

$${p}_{B} ( x ) = {\sum }_{j = 0}^{m - 1} {A}_{j} {x}^{j} .$$

The master node sends, to the r-th worker node, evaluations of p_{A}(x), p_{B}(x) at x=xᵣ, that is, it sends p_{A}(xᵣ), p_{B}(xᵣ) to the r-th worker node.

Worker nodes: For r∈{1, 2, . . . , P}, the r-th worker node computes the matrix product p_{C}(xᵣ)=p_{A}(xᵣ)p_{B}(xᵣ) and sends it to the fusion node on successful completion.

Fusion node (decoding): The fusion node uses outputs of any 2m−1 successful worker nodes to compute the coefficient of x^{m}−1 in the product p_{C}(x)=p_{A}(x)p_{B}(x). If the number of successful worker nodes is smaller than 2m−1. the fusion node declares a failure.

Notice that in MatDot Codes

$$A B = {\sum }_{i = 0}^{m - 1} {A}_{i} {B}_{i} \qquad ( 3 )$$

where Aᵢ and Bᵢ are as defined in Eq. (2). The simple observation of Eq. (3) leads to a different way of computing the matrix product as compared with Polynomial codes-based computation. In particular, to compute the product requires only, for each i, the product of Aᵢ and Bᵢ. Products of the form AᵢBⱼ for i≠j are not required, unlike for Polynomial codes, where, after splitting the matrices A and B in to m parts, all m² cross-products are required to evaluate the overall matrix product. This leads to a significantly smaller recovery threshold for the MatDot construction.

### PolyDot Codes

PolyDot is a code construction that unifies MatDot codes and Polynomial Codes to provide a trade-off between communication costs and recovery thresholds. Polynomial codes have a higher recovery threshold of m², but have a lower communication cost of [symbol] (N²/m²) per worker node. Conversely, MatDot codes have a lower recovery threshold of 2m−1, but have a higher communication cost of [symbol] (N²) per worker node. PolyDot code bridges the gap between Polynomial codes and MatDot codes, yielding intermediate communication costs and recovery thresholds, with Polynomial and MatDot codes as two special cases. As such, PolyDot codes may be viewed as an interpolation of MatDot codes and Polynomial codes. One extreme of the interpolation is MatDot codes and the other extreme is Polynomial codes.

An example of the PolyDot code technique is provided where m=4, s=2 and k=12. Matrix A is split into submatrices A_{0,0}, A_{0,1}, A_{1,0}, A_{1,1} each of dimension N/2×N/2. Similarly, matrix B is split into submatrices B_{0,0}, B_{0,1}, B_{1,0}, B_{1,1} each of dimension N/2×N/2, as follows:

$$A = [ \begin{matrix}{A}_{0 , 0} & {A}_{0 , 1} \\ {A}_{1 , 0} & {A}_{1 , 1}\end{matrix} ] , B = [ \begin{matrix}{B}_{0 , 0} & {B}_{0 , 1} \\ {B}_{1 , 0} & {B}_{1 , 1}\end{matrix} ] \qquad ( 4 )$$

Note that, from Eq. (4), the product AB can be written as:

$$AB = [ \begin{matrix}{\sum }_{i = 0}^{1} {A}_{0 , i} {B}_{i , 0} & {\sum }_{i = 0}^{1} {A}_{0 , i} {B}_{i , 1} \\ {\sum }_{i = 0}^{1} {A}_{1 , i} {B}_{i , 0} & {\sum }_{i = 0}^{1} {A}_{1 , i} {B}_{i , 1}\end{matrix} ] \qquad ( 5 )$$

The encoding functions can be defined as:

$$\begin{matrix}{p}_{A} ( x ) = {A}_{0 , 0} + {A}_{1 , 0} x + {A}_{0 , 1} {x}^{2} + {A}_{1 , 1} {x}^{3} \\ {p}_{B} ( x ) = {B}_{0 , 0} {x}^{2} + {B}_{1 , 0} + {B}_{0 , 1} {x}^{8} + {B}_{1 , 1} {x}^{6}\end{matrix}$$

Let x₁, . . . , xₚ be distinct elements of [symbol] . The master node sends p_{A}(xᵣ) and p_{B}(xᵣ) to the r-th worker node, r∈{1, . . . , P}, where the r-th worker node performs the multiplication p_{A}(xᵣ)p_{B}(xᵣ) and sends the output to the fusion node.

Let worker nodes 1, . . . , 12 be the first 12 worker nodes to send their computation outputs to the fusion node. The fusion node then obtains the matrices p_{A}(xᵣ), p_{B}(xᵣ) for all r∈{1, . . . , 12}. Because these 12 matrices can be seen as twelve evaluations of the matrix polynomial p_{A}(x)p_{B}(x) of degree 11 at twelve distinct points x₁, . . . , x₁₂, the coefficients of the matrix polynomial p_{A}(x)p_{B}(x) can be obtained using polynomial interpolation. This includes the coefficients of x^{i+2+6j} for all i, j∈{0,1} (i.e.,

$${\sum }_{k = 0}^{1} {A}_{i , k} {B}_{k , j}$$

for all i, j∈{0,1}). Once the matrices

$${\sum }_{k = 0}^{1} {A}_{i , k} {B}_{k , j}$$

for all i, j∈{0,1} are obtained, the product AB is obtained by Eq. (5).

The recovery threshold for m=4 in the example is k=12. This is larger than the recovery threshold of MatDot codes, which is k=2m−1=9, and smaller than the recovery threshold of Polynomial codes, which is k=m²=16. Hence, it can be seen that the recovery thresholds of PolyDot codes are somewhere between those of MatDot codes and Polynomial codes.

### Construction of PolyDot Codes

The following describes the general construction of PolyDot (m, s, t) codes. Note that although the two parameters m and s are sufficient to characterize a PolyDot code, the t is included in the parameters for better readability.

In the PolyDot code, matrices are split both horizontally and vertically, as such:

$$\begin{matrix}A = [ \begin{matrix}{A}_{0 , 0} & … & {A}_{0 , s - 1} \\ ⋮ & ⋱ & ⋮ \\ {A}_{t - 1 , 0} & … & {A}_{t - 1 , s - 1}\end{matrix} ] \\ B = [ \begin{matrix}{B}_{0 , 0} & … & {B}_{0 , t - 1} \\ ⋮ & ⋱ & ⋮ \\ {B}_{s - 1 , 0} & … & {B}_{s - 1 , t - 1}\end{matrix} ]\end{matrix} \qquad ( 6 )$$

where, for i=0, . . . , s−1 and j=0, . . . , t−1, submatrices A_{j,i} of A are N/t×N/s matrices and submatrices B_{i,j} of B are N/s×N/t matrices. Parameters s and t are chosen such that both s and t divide N and st=m.

Master node (encoding): Define the encoding polynomials as:

$$\begin{matrix}{p}_{A} ( x , y ) = {\sum }_{i = 0}^{t - 1} {\sum }_{j = 0}^{s - 1} {A}_{i , j} {x}^{i} {y}^{j} \\ {p}_{B} ( y , z ) = {\sum }_{k = 0}^{s - 1} {\sum }_{l = 0}^{t - 1} {B}_{k , l} {y}^{s - 1 - {k}_{Z} l}\end{matrix}$$

The master node sends to the r-th worker node the evaluations of p_{A}(x, y), p_{B}(y, z) at x=xᵣ,

$$y = {x}_{r}^{t} , z = {x}_{r}^{t ( 2 s - 1 )}$$

where all xᵣ are distinct for r∈{1, 2, . . . , P}. By this substitution, the three-variable polynomial to is transformed into a single-variable polynomial as follows:

$${p}_{C} ( x , y , z ) = {p}_{C} ( x ) = {\sum }_{i , j , k , l} {A}_{i , j} {B}_{k , l} {x}^{i + t ( s - 1 + j - k ) + t ( 2 s - 1 ) l}$$

The polynomial C(x) is evaluated at xᵣ for r=1, . . . , P.

Worker nodes: For r∈{1, 2, . . . , P}, the r-th worker node computes the matrix product p_{C}(xᵣ, yᵣ, zᵣ)=p_{A}(xᵣ, yᵣ)p_{B}(yᵣ, zᵣ) and sends it to the fusion node on successful completion.

Fusion node (decoding): The fusion node uses outputs of the first t²(2 s−1) successful worker nodes to compute the coefficient xⁱ⁻¹y^{s-1}z^{l-1} in C(x, y, z)=p_{A}(x,y)p_{B}(y,z). That is, it computes the coefficient of x^{i-1+(s-1)t+(2s-1)t(l-1)} of the transformed single-variable polynomial. If the number of successful worker nodes is smaller than t²(2 s−1), the fusion node declares a failure.

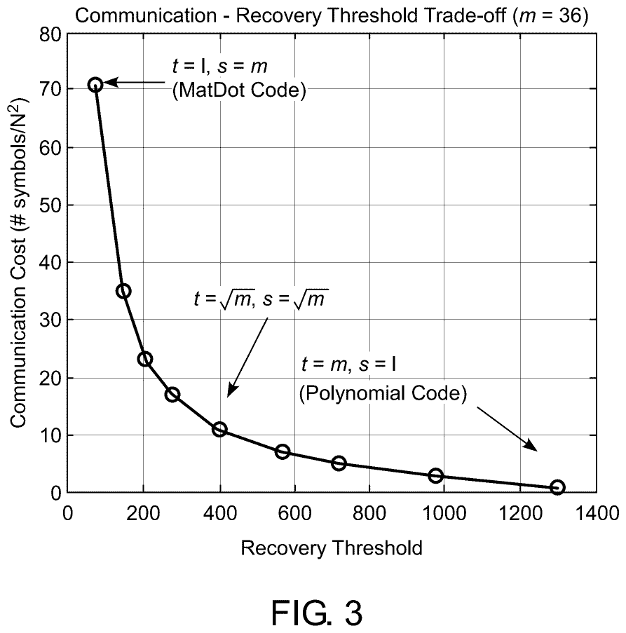

By choosing different values for s and t, communication cost and recovery threshold can be traded off. For s=m and t=1, PolyDot (m, s=m, t=1) code is a MatDot code which has a low recovery threshold but high communication cost. At the other extreme, for s=1 and t=m, PolyDot (m, s=1, t=m) code is a Polynomial code. Now consider a code with intermediate s and t values such as s=\sqrt{m} and t=\sqrt{m}. PolyDot (m, s=\sqrt{m}, t=\sqrt{m}) code has a recovery threshold of m (2\sqrt{m}−1)=Θ(m^{1.5}), and the total number of symbols to be communicated to the fusion node is Θ((N/\sqrt{m})²·m^{1.5})=Θ(\sqrt{m}N²), which is smaller than Θ(mN²), required by MatDot codes but larger than Θ(N²), required by Polynomial codes. This trade-off is illustrated in FIG. 3 for m=36.

Poly Dot codes essentially introduce a general framework which transforms the matrix-matrix multiplication problem into a polynomial interpolation problem with three variables x, y, z. For the PolyDot codes herein, the substitution y=x^{t} and z=x^{t(2s-1)} was used to convert the polynomial in three variables to a polynomial in a single variable, and it achieved a recovery threshold of t²(2 s−1). However, by using a different substitution, x=y^{t}, z=y^{st}, the recovery threshold can be improved to st²+s−1, which is an improvement within a factor of 2.

### Generalized PolyDot

Generalized PolyDot may be used to perform matrix-vector multiplication.

To partition the matrix, two integers m and n are chosen such that K=mn. Matrix W is block-partitioned both row-wise and column-wise into m×n blocks, each of size N/m×N/n. Let W_{i,j} denote the block with row index i and column index j, where i=0,1, . . . , m−1 and j=0, 1, . . . , n−1. Vector x is also partitioned into n equal parts, denoted by x₀, x₁, . . . , xₙ₋₁.

As an example, for m=n=2, the partitioning of W and x are:

$$W = [ \begin{matrix}{W}_{0 , 0} & {W}_{0 , 1} \\ {W}_{1 , 0} & {W}_{1 , 1}\end{matrix} ] , x = [ \begin{matrix}{x}_{0} \\ {x}_{1}\end{matrix} ]$$

To perform the matrix-vector product s=Wx using P nodes, such that every node can only store an N/m×N/n coded or uncoded submatrix (1/K fraction) of W, let the P^{th} node (p=0,1, . . . , P−1) store an encoded block of W which is a polynomial in u and v

$$\tilde{W} ( u , v ) = {\sum }_{i = 0}^{m - 1} {\sum }_{j = 0}^{n - 1} {W}_{i , j} {u}^{i} {v}^{j}$$

evaluated at (u, v)=(aₚbₚ). Each node also block-partitions x into n equal parts, and encodes them using the polynomial

$$\tilde{x} ( v ) = {\sum }_{l = 0}^{n - 1} {x}_{l} {v}^{n - l - 1}$$

evaluated at v=bₚ. Then, each node performs the matrix-vector product \tilde{W}(aₚ, bₚ)×(bₚ) which effectively results in the evaluation, at (u, v)=(aₚbₚ) of the following polynomial:

$$\tilde{s} ( u , v ) = \tilde{W} ( u , v ) \tilde{x} ( v ) = {\sum }_{l = 0}^{n - 1} {\sum }_{i = 0}^{m - 1} {\sum }_{j - 0}^{n - 1} {W}_{i , j} {x}_{l} {u}^{i} {v}^{n - l + j - 1}$$

even though the node is not explicitly evaluating it from all its coefficients. Now, fixing l=j, observe that the coefficient of uⁱvⁿ⁻¹ for i=0,1, . . . , m−1 turns out to be

$${\sum }_{j = 0}^{n - 1} {W}_{i , j} {x}_{j} = {s}_{i} .$$

Thus, these m coefficients constitute the m sub-vectors of s=Wx. Therefore, s can be recovered at any node if it can reconstruct these m coefficients of the polynomial \tilde{s}(u, v) in the equation above.

To illustrate this for the case where m=n=2, consider the following polynomial:

$$\tilde{s} ( u , v ) = ( {W}_{0 , 0} + {W}_{1 , 0} u + {W}_{0 , 1} v + {W}_{1 , 1} u v ) ( {x}_{0} v + {x}_{1} ) = {W}_{0 , 0} {x}_{1} + {W}_{1 , 0} {x}_{1} u + {W}_{0 , 1} {x}_{o} {v}^{2} + {W}_{1 , 1} {x}_{0} u {v}^{2} + {\underbrace{( {W}_{0 , 0} {x}_{0} + {W}_{0 , 1} {x}_{1} )}}_{{s}_{0}} v + {\underbrace{( {W}_{1 , 0} {x}_{0} + {W}_{1 , 1} {x}_{1} )}}_{{s}_{1}} uv$$

The substitution u=vⁿ is then used to convert \tilde{s}(u, v) into a polynomial in a single variable. Some of the unwanted coefficients align with each other (e.g. u and v²), but the coefficients of uⁱvⁿ⁻¹=vⁿⁱ⁺ⁿ⁻¹ stay the same (i.e., sᵢ for i=0, 1, . . . , m−1).

The resulting polynomial is of degree mn+n−2. Thus, all the coefficients of this polynomial can be reconstructed from P distinct evaluations of this polynomial at P nodes, if there are at most P−mn−n+1 erasures or

$$\frac{P - m n - n + 1}{2}$$

errors.

### Using Generalized PolyDot Coding to Implement a DNN Training Strategy

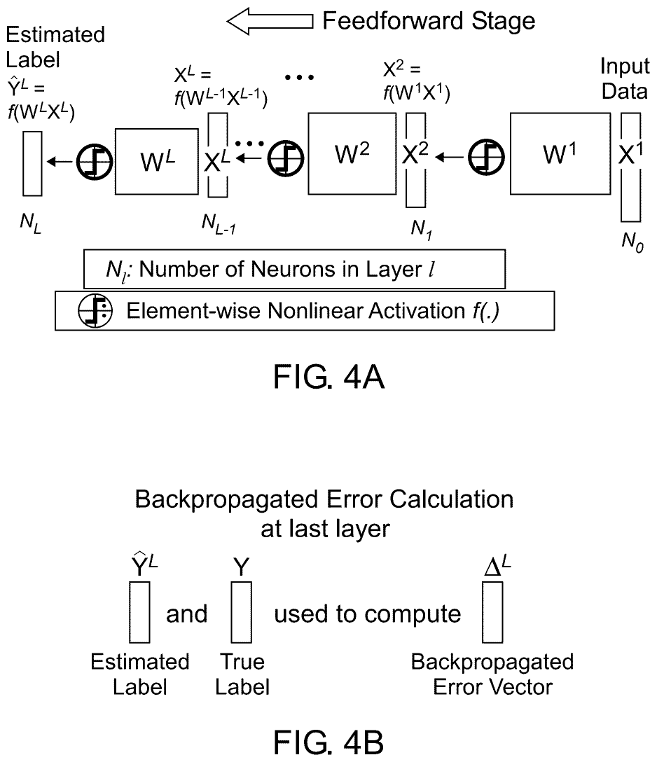

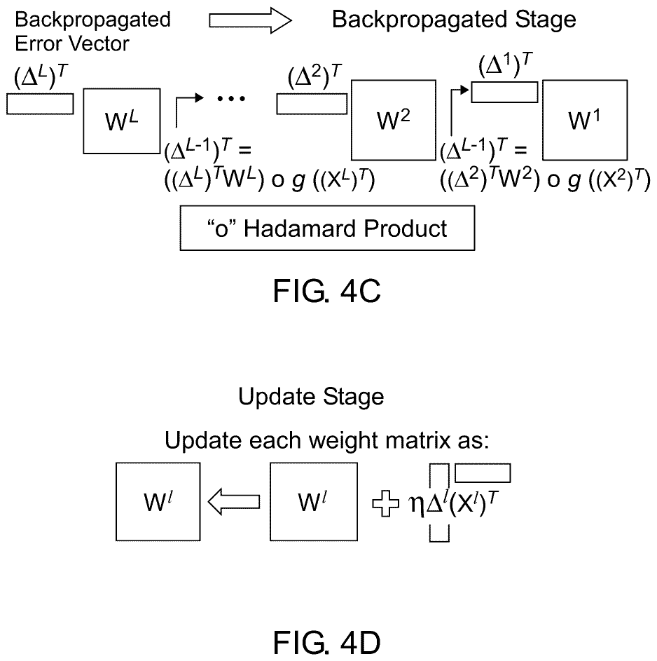

A DNN with L layers is being trained using backpropagation with Stochastic Gradient Descent with a “batch size” of 1. The DNN thus consists of L weight matrices, one for each layer, as shown in FIG. 4. At the l-th layer, Nₗ denotes the number of neurons. Thus, the weight matrix to be trained is of dimension Nₗ×Nₗ−1. For simplicity, assume that Nₗ=N for all layers.

In every iteration, the DNN (i.e. the L weight matrices) is trained based on a single data point and its true label through three stages, namely, feedforward, backpropagation and update, as shown in FIGS. 4A-4D. At the beginning of every iteration, the first layer accesses the data vector (input for layer 1) from memory and starts the feedforward stage which propagates from layer l=1 to L. For a layer, denote the weight matrix, input for the layer and backpropagated error for that layer by W, x and δ respectively. The operations performed in layer l during feedforward stage, as shown in FIG. 4A, can be summarized as:
O1: Compute matrix-vector product s=Wx.
C1: Compute input for layer (l+1) given by ƒ(s) where ƒ(⋅) is a nonlinear activation function applied elementwise.

At the last layer (l=L), the backpropagated error vector is generated by accessing the true label from memory and the estimated label as output of last layer, as shown in FIG. 4B. Then, the backpropagated error propagates from layer L to 1, as shown in FIG. 4C, also updating the weight matrices at every layer alongside, as shown in FIG. 4D. The operations for the backpropagation stage can be summarized as:
O2: Compute matrix-vector product c^{T}=δ^{T}W.
C2: Compute backpropagated error vector for layer (l−1) given by C^{T}D where D is a diagonal matrix whose i-th diagonal element depends only on the i-th value of x.

Finally, the step in the update stage is as follows:
O3: Update as: W←W+ηδx^{T} where η is the learning rate.

Parallelization Scheme: It is desirable to have fully decentralized, model parallel architectures where each layer is parallelized using P nodes for each layer (that can be reused across layers) because the nodes cannot store the entire matrix W for each layer. As the steps O1, O2 and O3 are the most computationally intensive steps at each layer, the strategy is restricted to schemes where these three steps for each layer are parallelized across the P nodes. In such schemes, the steps C1 and C2 become the steps requiring communication as the partial computation outputs of steps O1 and O2 at one layer are required to compute the input x or backpropagated error δ for another layer, which is also parallelized across all nodes.

The goal is to design a unified coded DNN training strategy, denoted by C(N,K,P), using P nodes such that every node can effectively store only a 1/K fraction of the entries of W for every layer. Thus, each node has a total storage constraint of

$$\frac{L {N}^{2}}{K}$$

along with negligible additional storage of

$$O ( \frac{L {N}^{2}}{K} )$$

for vectors that are significantly smaller compared to matrices. Additionally, it is desirable that all additional communication complexities and encoding/decoding overheads should be negligible in scaling sense compared to the computational complexity of the steps O1, O2 and O3 parallelized across each node, at any layer.

Essentially, it is required to perform coded “post” and “pre” multiplication of the same matrix W with vectors x and δ^{T} respectively at each layer, along with all the other operations mentioned above. As outputs are communicated to other nodes at steps C1 and C2, it is desirable to be able to correct as many erroneous nodes as possible at these two steps, before moving to another layer.

An initial encoding scheme is proposed for W at each layer such that the same encoding allows the coded “post” and “pre” multiplication of W with vectors x and δ^{T} respectively at each layer in every iteration. The key idea is that W is encoded only for the first iteration. For all subsequent iterations, vectors are encoded and decoded instead of matrices. As shown below, the encoded weight matrix W is able to update itself, maintaining its coded structure.

Initial Encoding of W: Every node receives an N/m×N/n submatrix (or block) of W encoded using Generalized PolyDot. For p=0, 1, . . . , P−1 node p stores \tilde{W}ₚ: =\tilde{W}(u, v)|ᵤ₌ₐ_{ₚ}_{,v=b}_{ₚ} at the beginning of the training which has N²/K entries. Encoding of the matrix is done only in the first iteration.

Feedforward Stage: Assume that the entire input x to the layer is available at every node at the beginning of step O1. Also assume that the updated \tilde{W}ₚ of the previous iteration is available at every node, an assumption that is justified because the encoded sub-matrices of W are able to update themselves, preserving their coded structure.

For p=0, 1, . . . , P−1, node p block partitions x and generates the codeword \tilde{x}ₚ: =\tilde{x}(v)|_{v=b}_{ₚ}. Next, each node performs the matrix-vector product \tilde{s}ₚ=\tilde{W}ₚ\tilde{x}ₚ and sends this product (polynomial evaluation) to every other node where some of these products may be erroneous. If every node can still decode the coefficients of uⁱvⁿ⁻¹ for i=o, 1, . . . , m−1, then it can successfully decode s.

One of the substitutions u=vⁿ or v=u^{m} is used to convert \tilde{s}(u, v) into a polynomial in a single variable and then standard decoding techniques are used to interpolate the coefficients of a polynomial in one variable from its evaluations at P arbitrary points when some evaluations have an additive error. Once s is decoded, the nonlinear function ƒ(⋅) is applied element-wise to generate the input for the next layer. This also makes x available at every node at the start of the next feedforward layer.

Regeneration: Each node can not only correct t_{ƒ} erroneous nodes but can also locate which nodes were erroneous. Thus, the encoded W stored at those nodes are regenerated by accessing some of the nodes that are known to be correct.

Additional Steps: Similar to replication and MDS code-based strategy, the DNN is checkpointed at a disk at regular intervals. If there are more errors than the error tolerance, the nodes are unable to decode correctly. However, as the error is assumed to be additive and drawn from real-valued, continuous distributions, the occurrence of errors is still detectable even though they cannot be located or corrected, and thus the entire DNN can again be restored from the last checkpoint.

To allow for decoding errors, one more verification step must be included where all nodes exchange their assessment of node outputs, i.e., a list of nodes that they found erroneous and compare. If there is a disagreement at one or more nodes during this process, it is assumed that there have been errors during the decoding, and the entire neural network is restored from the last checkpoint. Because the complexity of this verification step is low in scaling sense compared to encoding/decoding or communication (because it does not depend on N), it is assumed that it is error-free because the probability of soft-errors occurring within such a small duration is negligible as compared to other computations of longer durations.

Backpropagation Stage: The backpropagation stage is very similar to the feedforward stage. The backpropagated error δ^{T} is available at every node. Each node partitions the row-vector into m equal parts and encodes them using the polynomial:

$${\tilde{δ}}^{T} ( u ) = {\sum }_{l = 0}^{m - 1} {δ}_{l}^{T} {u}^{m - l - 1}$$

For p=0,1, . . . , P−1 the p-th node evaluates \tilde{δ}^{T}(u) at u=aₚ yielding

$${\tilde{δ}}_{p}^{T} = {\tilde{δ}}^{T} ( {a}_{p} ) .$$

Next, it performs the computation

$${\tilde{c}}_{p}^{T} = {\tilde{δ}}_{p}^{T} {\tilde{W}}_{p}$$

and sends the product to all the other nodes, of which some products may be erroneous. Consider the polynomial:

$${\tilde{c}}^{T} ( u , v ) = {\tilde{δ}}^{T} ( u ) \tilde{W} ( u , v ) = {\sum }_{l = 0}^{m - 1} {\sum }_{i = 0}^{m - 1} {\sum }_{j = 0}^{n - 1} {δ}_{l}^{T} {W}_{i j} {u}^{m - l + i - 1} {v}^{j}$$

The products computed at each node effectively result in the evaluations of this polynomial \tilde{c}^{T}(u, v) at (u, v)=(aₚ, bₚ). Similar to feedforward stage, each node is required to decode the coefficients of u^{m-1}v^{j} in this polynomial for j=0, 1, . . . , n−1 to reconstruct c^{T}. The vector c^{T} is used to compute the backpropagated error for the consecutive, i.e., the (l−1)-th layer.

Update Stage: The key part is updating the coded Wₚ. Observe that, since x and δ are both available at each node, it can encode the vectors as

$${\sum }_{i = 0}^{m - 1} {δ}_{i} {u}^{i} and {\sum }_{j = 0}^{n - 1} {x}_{j}^{T} {v}^{j}$$

at u=aₚ and v=bₚ respectively, and then update itself as follows:

$${\tilde{W}}_{p} ← {\tilde{W}}_{p} + η ( {\sum }_{i = 0}^{m - 1} {δ}_{i} {a}_{p}^{i} ) ( {\sum }_{j = 0}^{n - 1} {x}_{j}^{T} {b}_{p}^{j} ) = {\sum }_{i = 0}^{m - 1} {{\sum }_{j = 0}}^{n - 1} ( {\underbrace{{W}_{i j} + η {δ}_{i} {x}_{j}^{T}}}_{Update of {W}_{i j}} ) {a}_{p}^{i} {b}_{p}^{j}$$

The update step preserves the coded nature of the weight matrix, with negligible additional overhead. Errors occurring in the update stage corrupt the updated submatrix without being immediately detected as there is no output produced. The errors exhibit themselves only after step O1 in the next iteration at that layer, when that particular submatrix is used to produce an output again. Thus, they are detected (and if possible corrected) at C1 of the next iteration.

1. A system for training a neural network having L layers, comprising:
a master node;
a fusion node;
a plurality of worker nodes arranged in a communicative network with the master node and the fusion node;
distributed software, executing on the master node, the plurality of worker nodes and the fusion node iterating the functions of:
executing a feedforward stage comprising:
retrieving an input vector and a ground truth vector;
computing, at each layer, a matrix-vector product of a weight matrix and the input vector; and
computing, at each layer, x^{l}, an input vector for the next layer by application of a non-linear activation function to the result of the matrix-vector product of the weight matrix and the input vector; and
executing a backpropagation stage comprising:
computing, at a last layer, Δ^{L}, an error vector by comparison of an output vector of the last layer to the ground truth vector;
computing, at each layer, c^{T}, a matrix-vector product of the error vector Δ^{L} and the weight matrix; and
computing, at each layer, an error vector Δ^{l-1} for the for the next layer by computing a product of c^{T} and a diagonal matrix;
wherein the matrix-vector product of the weight matrix and the input vector at each layer is computed using generalized PolyDot coding; and
wherein the matrix-vector product of the error vector and the weight matrix at each layer is computed using generalized PolyDot coding.

2. The system of claim 1 wherein the i^{th} of the diagonal matrix is derived from the i^{th} element of the input vector x^{L} for that layer.

3. The system of claim 1 wherein using generalized PolyDot coding comprises parallelizing each layer using P worker nodes by the steps of:
sending, at a first iteration, a submatrix of the weigh matrix for each layer encoded in polynomial form using generalized PolyDot coding to each of the P nodes;
sending, at each iteration of the feedforward stage, the input vector for each layer to each of the P nodes; and
sending, at each iteration of the backpropagation stage, the error vector for each layer to each of the P nodes.

4. The system of claim 3 wherein the generalized PolyDot coding comprises:
at the master node:
partitioning the weight matrix at each layer horizontally and vertically into P submatrices of size
$$\frac{N}{m} \times \frac{N}{n} ;$$
and
at the first iteration, encoding the submatrix received from the master node into a polynomial form as a function of one or more worker-node-specific parameters;
sending each of the encoded submatrices to one of the P worker nodes;
at each of the P worker nodes:
partitioning the input vector or the weight vector into a plurality of sub-vectors, each of size n;
at each iteration, encoding the input vector or the weight vector into a polynomial form as a function of one of the one or more worker-node-specific parameters;
performing a polynomial multiplication of the encoded submatrix and encoded vector;
reducing the product of the polynomial multiplication to a single variable polynomial by substitution; and
sending the results of the polynomial multiplication to every other worker node;
at the fusion node:
combining the results of at least mn+n−2 worker nodes to yield the product of the weight matrix and the input vector or error vector.

5. The system of claim 4 wherein each submatrix is encoded at a worker node in polynomial form using the polynomial:
$$\tilde{W} ( {a}_{p} , {b}_{p} ) = {\sum }_{i = 0}^{m - 1} {\sum }_{j = 0}^{n - 1} {W}_{i , j} {a}_{p}^{i} {b}_{p}^{j}$$
wherein aₚ, bₚ are the worker-node-specific parameters and W_{i,j} is the submatrix.

6. The system of claim 5 wherein each sub-vector is encoded at a worker node in polynomial form using the polynomial:
$$\tilde{x} ( {b}_{p} ) = {\sum }_{l = 0}^{n - 1} {x}_{l} {b}_{p}^{n - l - 1}$$
wherein bₚ is the worker-node-specific parameter and xₗ is the sub-vector.

7. The system of claim 5 wherein the polynomial multiplication of the encoded submatrix and encoded vector is given by:
$$\tilde{s} ( {a}_{p} , {b}_{p} ) = \tilde{W} ( {a}_{p} , {b}_{p} ) \tilde{x} ( {b}_{p} ) = {\sum }_{l = 0}^{n - 1} {\sum }_{i = 0}^{m - 1} {\sum }_{j = 0}^{n - 1} {W}_{i , j} {x}_{l} {a}_{p}^{i} {b}_{p}^{n - l + j - 1}$$

8. The system of claim 7 wherein the product of the polynomial multiplication is reduced to a single variable polynomial by the substitution
$${a}_{p} = {b}_{p}^{n} .$$

9. The system of claim 1 wherein a single node acts as both the master node and the fusion node.
